(19) United States
(12) Patent Application Publication
(10) Pub. No.: US 2013/0167152 A1
(43) Pub. Date: Jun. 27, 2013

(54) MULTI-CORE-BASED COMPUTING APPARATUS HAVING HIERARCHICAL SCHEDULER AND HIERARCHICAL SCHEDULING METHOD

(71) Applicant: Hyun-Ku JEONG, Daejeon-si (KR)

(72) Inventor: Hyun-Ku JEONG, Daejeon-si (KR)

(21) Appl. No.: 13/726,300

(22) Filed: Dec. 24, 2012

(30) Foreign Application Priority Data
Dec. 26, 2011 (KR) 10-2011-0142457

(51) Int. Cl. G06F 9/48

(52) U.S. Cl. CPC G06F 9/4881
USPC 718/102

(57) ABSTRACT

A computing apparatus includes a global scheduler configured to schedule a job group on a first layer, and a local scheduler configured to schedule jobs belonging to the job group according to a set guide on a second layer. The computing apparatus also includes a load monitor configured to collect resource state information associated with states of physical resources and set a guide with reference to the collected resource state information and set policy.

### CROSS-REFERENCE TO RELATED APPLICATION(S)

This application claims the benefit under 35 U.S.C. §119(a) of Korean Patent Application No. 10-2011-0142457, filed on Dec. 26, 2011, in the Korean Intellectual Property Office, the entire disclosure of which is incorporated herein by reference for all purposes.

### BACKGROUND

1. Field

The following description relates to a multi-core system and a hierarchical scheduling system.

2. Description of the Related Art

Multi-core systems employing virtualization technology generally include at least one virtual layer and a physical layer, which in conjunction with various other components can execute a series of procedures often referred to as hierarchical scheduling. In a hierarchical scheduling scenario, the physical layer generally manages each of the virtual layer(s), and each of the virtual layer(s) is generally provided to execute various jobs. The physical layer may utilize a global scheduler to determine which virtual layer to execute, whereas the virtual layer may utilize a local scheduler to determine which job to execute.

For example, in procedural hierarchical scheduling, a global scheduler may select a virtual layer for a physical layer to execute. Accordingly and in response to a local scheduler, the selected virtual layer selects which job to be executed.

Load balancing can generally be described as an even division of processing work between two or more devices (e.g., computers, network links, storage devices and the like), which can result in faster service and higher overall efficiency. Generally, load balancing is performed on at least one or more of the hierarchical scheduler(s) (e.g., global and local) in, for example, a multi-core system having multiple physical processers. In cases where there is no load balancing performed on the hierarchical scheduler(s), it can be difficult to improve the performance of a multi-core system having multiple physical processors. As a result, hierarchical scheduler(s) generally have a load balancing function. Generally, load balancing on the multi-core system having hierarchical schedulers may be applied to one hierarchical scheduler or may be applied independently to more than one up to and including all of the hierarchical schedulers.

However, in systems where only a virtual layer performs load balancing or the virtual layer and a physical layer perform load balancing independently of each other, a load migration that is inappropriate and unsuitable for actual system conditions may result. In addition, since the virtual layer and the physical layer are not in close collaboration with each other, unnecessary cache miss can be generated, thereby degrading system performance.

### SUMMARY

In one general aspect, there is provided a computing apparatus comprising: a global scheduler on a first layer configured to schedule at least one job group; a load monitor configured to collect resource state information associated with states of physical resources and set a guide with reference to the collected resource state information and set policy; and a local scheduler on a second layer configured to schedule jobs belonging to the job group according to the set guide.

The first layer may include a physical platform based on at least one physical core and the second layer may include a plurality of virtual platforms based on at least one virtual core, which are managed by the physical platform.

The guide may be represented based on at least one of a rate of distribution of load among the virtual cores, a target resource amount of at least one and up to each of the virtual cores, and a target resource amount of at least one and up to each of the physical cores, and the guide may define a detailed scheduling method of the local scheduler.

The policy may include a type of a guide for use and/or a purpose of a defined schedule. The purpose of a defined schedule may include at least one of priorities between the global scheduler and the local scheduler, a scheduling method of the global scheduler and a scheduling method of the local scheduler in consideration of at least one of load allocated to at least one and up to each of the physical cores, power consumption of at least one and up to each of the physical cores, and a temperature of at least one and up to each of the physical cores.

In another general aspect, there is provided a computing apparatus comprising: a first layer based on a physical core to perform load balancing on a job group-by-job group basis using a global scheduler; and a second layer based on a virtual core to perform load balancing on a job-by-job basis using a local scheduler wherein the jobs are belonging to the job group, wherein the first layer sets a guide related to an operation of the local scheduler according to physical resource states and a set policy.

In another general aspect, there is provided a hierarchical scheduling method of a multi-core computing apparatus which comprises a global scheduler configured to schedule at least one job group on a first layer and a local scheduler configured to schedule a job belonging to the job group on a second layer, the hierarchical scheduling method comprising: collecting resource state information associated with states of physical resources; and setting a guide for the local scheduler with reference to the collected resource state information and a set policy.

Other features and aspects may be apparent from the following detailed description, the drawings, and the claims.

### BRIEF DESCRIPTION OF THE DRAWINGS

FIG. 1 is a diagram illustrating an example of a computing apparatus according to one embodiment of the present disclosure.

FIG. 2 is a diagram illustrating another example of a computing apparatus according to another embodiment the present disclosure.

FIG. 3 is a diagram illustrating an example of a schedule operation of a computing apparatus according to one embodiment of the present disclosure.

FIG. 4 is a diagram illustrating another example of a scheduling operation of a computing apparatus according to another embodiment of the present disclosure.

FIG. 5 is a diagram illustrating another example of a scheduling operating of a computing apparatus according to one embodiment of the present disclosure.

FIG. 6 is a diagram illustrating an example of a load balancing method using a global scheduler according to one embodiment of the present disclosure.

FIG. 7 is a flowchart illustrating an example of a hierarchical scheduling method according to the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

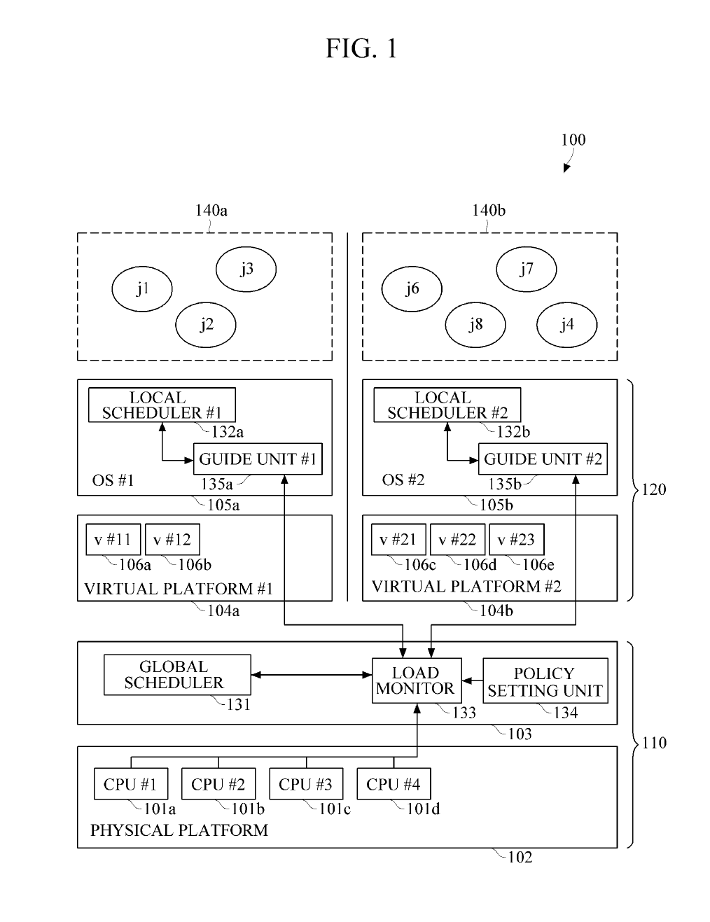

FIG. 1 is a diagram illustrating an example of a computing apparatus according to one embodiment of the present disclosure.

Referring to FIG. 1, the computing apparatus 100 may be a multi-core system having a hierarchical structure. For example, the computing apparatus 100 may include a first layer 110 and a second layer 120. The first layer 110 may include a physical platform 102 based on multiple physical cores 101a, 101b, 101c, and 101d and a virtual machine monitor (VMM) (or a hypervisor) 103 running on the physical platform 102. The second layer 120 may include multiple virtual platforms 104a and 104b which may be managed by the VMM 103 and operating systems (OSs) 105a and 105b that run on the virtual platforms 104a and 104b, respectively. Some or all of the virtual platforms 104a and 104b may include multiple virtual cores 106a and 106b and 106c, 106d, and 106e.

In addition, the computing apparatus 100 may include a hierarchical scheduler. For example, the first layer 110 may include a global scheduler 131 that can schedule a job group, and the second layer 120 may include local schedulers 132a and 132b that can schedule one and up to each of jobs j1, j2, j3, j4, j6, j7 and/or j8 belonging to a job group 140a or a job group 140b, that is respectively scheduled by the global scheduler 131.

The global scheduler 131 and the local schedulers 132a and 132b may operate in a hierarchical manner, as described herein. For example, when the physical platform 102 schedules the virtual platforms 104a and 104b and the respective job groups 140a and 140b to be executed on the virtual platforms 104a and 104b by use of the global scheduler 131, the scheduled virtual platform (for example, 104a) may be able to schedule one or more of jobs j1 through j3 that belong to the job group 140a by use of the local scheduler 132a. In this example, load balancing performed by the global scheduler 131 on the first layer 110 may be referred to as “L1 L/B” and load balancing carried out by the local schedulers 132a and 132b on the second layer 120 may be referred to as “L2 L/B.”

In addition, the computing apparatus 100 may further include one or more of a load monitor 133, a policy setting unit 134, and guide units 135a and 135b, in addition to the global scheduler 131 and the local schedulers 132a and 132b.

As described above, the global scheduler 131 and the local schedulers 132a and 132b may operate in a hierarchical manner. In other words, the global scheduler 131 schedules the job groups 140a and 140b, and the local schedulers 132a and 132b schedule jobs j1, j2, j3, j4, j6, j7 and/or j8) belonging to the respective job groups 140a and 140b.

In some embodiments, the local schedulers 132a and 132b may schedule the jobs according to predetermined guide. As suitable guides, for example, the guide may refer to abstraction information regarding utilization of at least one and up to each the physical cores 101a, 101b, 101c, and/or 101d to be provided by the first layer 110 to the second layer 120. The expression form and examples of the guide will be described later. In some embodiments, the guide may be set by the load monitor 133.

In some embodiments, the load monitor 133 may collect resource state information of physical resources, and build the guide with reference to the collected resource state information and the set policy. For example, the load monitor 133 may collect resource state information which may include but is not limited to a mapping relationship between some or each of the physical cores 101a, 101b, 101c and/or 101d and some or each of the physical cores 106a, 106b, 106c, 106d, and/or 106e, and the utilization usage of some or each of the physical cores 101a, 101b, 101c, and/or 101d, the amount of work on a work queue, a temperature, a frequency, power consumption, and the like.

In addition, the load monitor 133 may make a guide based on the policy previously set by the policy setting unit 134 and/or the collected resource state information, and transmit the guide to the guide units 135a and 135b. In some embodiments, the guide units 135a and 135b may transmit the received guide to the corresponding local schedulers 132a and 132b so that the local schedulers 132a and 132b can perform scheduling tasks according to the received guide.

In one example, the load monitor 133 may set guides independent of each other and provide the first local scheduler 132a and the second local scheduler 132b with the respectively set guides. In other words, the load monitor 133 may show the actual state of the physical platform 102 to both the local schedulers 132a and 132b, or the load monitor 122 may show different virtual states of the physical platform 102 to the local schedulers 132a and 132b according to the set policy. For example, a guide provided to the first local scheduler 132a can be different from the guide that is provided to the second local scheduler 132b. The guides provided to the first and the second local scheduler (132a and 132b) may also be similar or, in some embodiments, be identical.

In another example, the load monitor 133 may be provided on the first layer 110 and the guide units 135a and 135b may be provided on the second layer 120. However, the disposition of the load monitor 133 and the guide units 135a and 135b is provided for exemplary purposes. In some embodiments, the load monitor 133 may be provided regardless of the hierarchical structure, and in other embodiments the global scheduler 131 may function as the load monitor 133.

In another example, the guide units 135a and 135b may be formed based on a message, a software or hardware module, a shared memory region, and the like. Furthermore, in some embodiments, without the aid of the guide units 135a and 135b, the global scheduler 131 or the load monitor 133 may directly transmit the guides to the local schedulers 132a and 132b.

The guides may be defined by the load monitor 133 based on at least one or more of a rate of load distribution among at least one and up to each of the virtual cores 106a, 106b, 106c, 106d, and/or 106e, a target resource amount of at least one and up to each of the virtual cores 106a, 106b, 106c, 106d, and/or 106e, and/or a target resource amount of at least one and up to each of the physical cores 101a, 101b, 101c, and/or 101d.

The policy setting unit 134 may determine which guide is to be used, for example, the type of a guide and a purpose of a specific schedule. The purpose of schedule may be expressed, for example, as “since a specific physical core has a great load thereon, migrate a job on the physical core to another physical core and do not migrate any other job to that physical core, “since a specific physical core has consumed a significant amount of power, migrate a job on the physical core to another physical core,” “since a specific physical core has generated a great amount of heat, migrate a job on the physical core to another physical core, or “operate a global scheduler first in a specific circumstance,” including other purpose of schedules not expressly contained here.

Accordingly, in some embodiments, the purpose of a schedule may include one or more of the priority between schedules, a detailed scheduling method of each scheduler, and/or the like. As such, the load monitor 133 may provide the local schedulers 132a and 132b with the guides that are set independent of each other with reference to the resource state information and/or the set policy, and the local schedulers 132a and 132b can perform the schedules according to the provided guides, so that the performance of the system can be improved by performing load balancing (L/B) in accordance with the defined purpose.

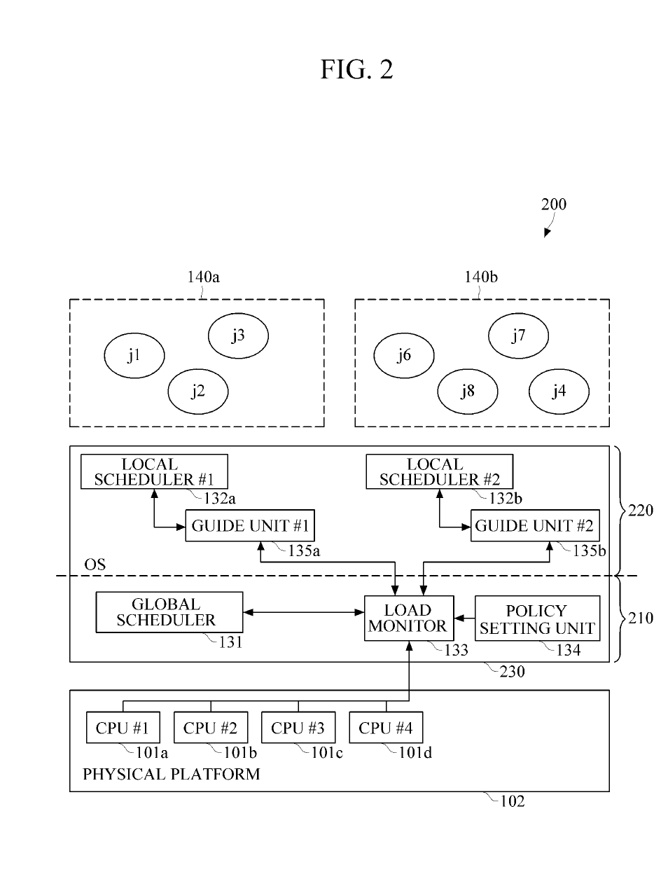

FIG. 2 is a diagram illustrating another example of a computing apparatus according to another embodiment of the present disclosure.

Referring to FIG. 2, a computing apparatus 200 may include a global scheduler 131, local schedulers 132a and 132b, a load monitor 133, a policy setting unit 134, and guide units 135a and 135b. The above listed components in FIG. 2 correspond to those found in the exemplary computing apparatus 100 illustrated in FIG. 1, and thus detailed descriptions thereof will not be reiterated.

Unlike the exemplary computing apparatus 100 illustrated in FIG. 1, the computing apparatus 200 shown in the example illustrated in FIG. 2 may include a physical platform 102 without virtual platforms 104a and 104b, as found in FIG. 1. For example, an operating system 230 may include a first virtual layer 210 and a second virtual layer 220, and have the global scheduler 131 on the first virtual layer 210 and the local schedulers 132a and 132b on the second virtual layer 220. In some embodiments, the first virtual layer 210 and the second virtual layer 220 are logical or conceptual partitions, and thus they are distinguishable from a virtual machine (VM) and a virtual machine monitor (VMM). For example, the local schedulers 132a and 132b shown in the example illustrated in FIG. 1 are present on a user level, whereas the local schedulers 132a and 132b shown in the example illustrated in FIG. 2 may be present on a kernel layer.

In addition, in FIG. 2, at least one and up to each of the jobs (for example, j1 through j7) may be executed on the physical platform 102. For example, jobs j1 to j3 may be scheduled by a first local scheduler 132a and jobs j4 to j7 may be scheduled by a second local scheduler 132b. Each local scheduler 132a and 132b may use some or all of physical cores 101a, 101b, 101c, and/or 101d. The global scheduler 131 may schedule resources to be distributed to one or both of the local schedulers 132a and 132b.

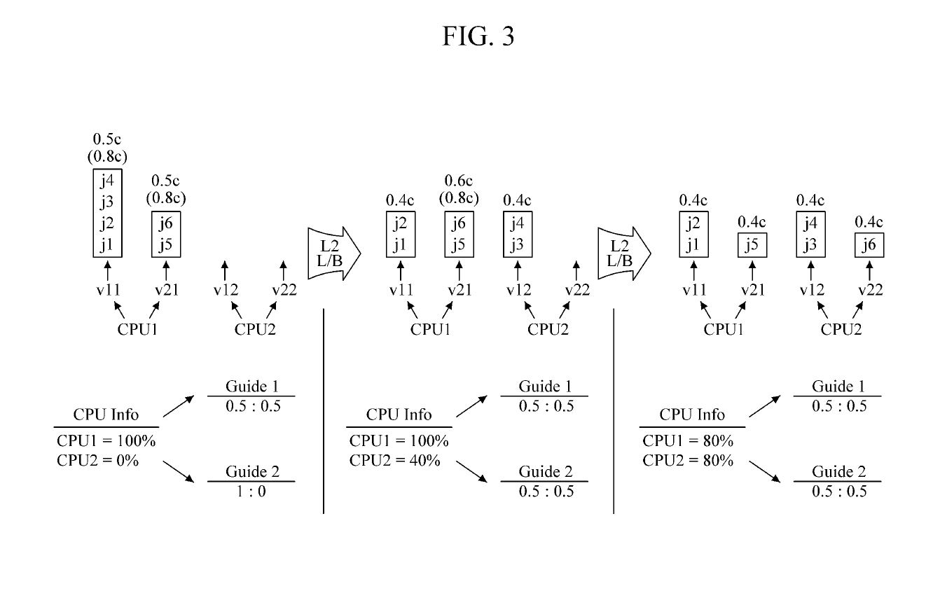

FIG. 3 is a diagram illustrating an example of a schedule operation of a computing apparatus according to one embodiment of the present disclosure. The example illustrated in FIG. 3 may be applied to the computing apparatus 100 illustrated in FIG. 1 or to the computing apparatus 200 illustrated in FIG. 2 and other computing apparatuses not described specifically herein. The exemplary schedule operation illustrated in FIG. 3 may also assume that a rate of distribution of load among virtual cores is used as guide information.

Referring to FIG. 3, ‘CPU1’ and ‘CPU2’ represent physical cores (or physical processors). ‘v11’ and ‘v21’ represent virtual cores (or virtual processors) that are allocated to ‘CPU1.’ Similarly, ‘v12’ and ‘v22’ represent virtual cores that are allocated to ‘CPU2.’ ‘j1’ to ‘j6’ represent jobs to be executed. ‘CPU Info’ represents resource state information collected by a load monitor 133, and ‘Guide 1’ and ‘Guide 2’ represent guide information for the respective first local scheduler 132a and second local scheduler 132b.

Referring to FIGS. 1 and 3, the load monitor 133 may collect the resource state information. For example, as shown in the left-handed side in FIG. 3, the load monitor 133 may learn that CPU1 is used at 100% and CPU2 is used at 0%. Accordingly, in this example, the load monitor 133 sets guide information with reference to the collected resource state information and the set policy. For example, the load monitor 133 may set Guide 1 as 0.5:0.5 and Guide 2 as 1:0.5 based on the rate of distribution of load among the virtual cores. This may indicate that jobs are equally allocated to v11 and v12 on a first virtual platform 104a and that all jobs are allocated to v21 on a second virtual platform 104b.

According to the set guide information, each local scheduler 132a and 132b schedules at least one and up to each of the jobs j1 to j6. For example, the first local scheduler 132a may move jobs j3 and j4 to v12 from v11 to which the jobs 13 and j4 have been originally allocated. In addition, since the second local scheduler 132b in this example conforms to the current guide information, it may not perform the schedule.

As described above, when load balancing is performed by the local schedulers 132a and 132b, CPU1 and CPU2 may exhibit utilization rates of 100% and of 40%, respectively, as shown in the middle portion of FIG. 3. In this example, the load monitor 133 may update the guide information since CPU2 has remaining resources. For example, the load monitor 133 may change Guide 2 to 0.5:0.5.

Then, in this example, as shown in the right-handed side of FIG. 3, the job j6 that has been originally allocated to v21 is moved to v22, and each of the utilization rates of CPU1 and CPU2 may become 80%.

One noteworthy aspect is that VP guide does not have to show the actual state of CPU utilization. For example, even though Guide 2 is offering advice to utilize v21 since CPU to which v22 is allocated is very busy, CPU2 to which v22 is allocated is currently idle as shown in the left-handed side of FIG. 3.

In addition, not all guides have to show the same condition. In the above example, Guide 1 and Guide 2 indicate different information. The physical platform 102 may perform hierarchical scheduling based on the guides according to the predetermined purpose or policy.

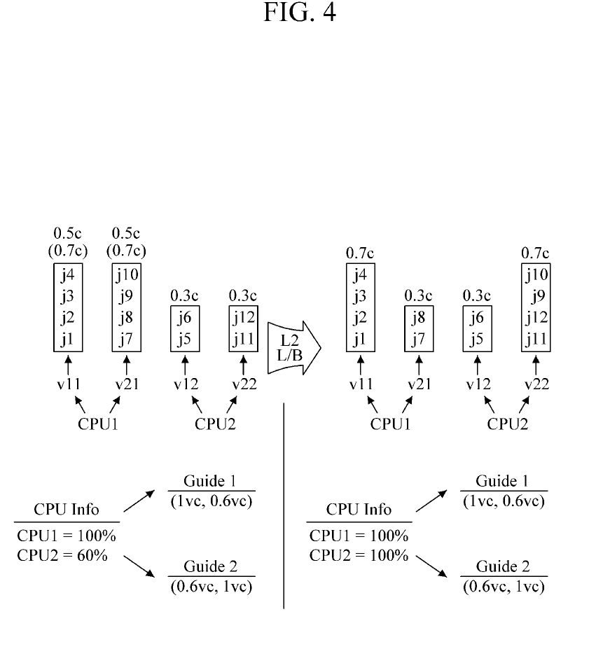

FIG. 4 is a diagram illustrating another example of a scheduling operation of a computing apparatus according to another embodiment of the present disclosure. The example illustrated in FIG. 4 may be applied to the computing apparatus 100 illustrated in FIG. 1 or the computing apparatus 200 illustrated in FIG. 2 in addition to computing apparatuses not specifically described herein, and the scheduling operation of FIG. 4 may assume that a target resource amount of each virtual core is used as guide information.

Referring to FIG. 4, ‘CPU1’ and ‘CPU2’ represent physical cores (or physical processors). ‘v11’ and ‘v21’ represent virtual cores (or virtual processors) that are allocated to ‘CPU1.’ Similarly, ‘v12’ and ‘v22’ represent virtual cores that are allocated to ‘CPU2.’ ‘j1’ to ‘j12’ represent jobs to be executed. ‘CPU Info’ represents resource state information collected by a load monitor 133, and ‘Guide 1’ and ‘Guide 2’ represent guide information for the respective first local scheduler 132a and second local scheduler 132b.

As described herein, a maximum resource amount to be provided by one physical core is represented by ‘1 c,’ and a maximum resource amount to be provided by one virtual core is represented by ‘1 vc.’ For example, if one virtual core is set to use 50% of one physical core at maximum, such a relationship as ‘1 vc=0.5 c’ may be established.

Referring to FIGS. 1 and 4, the load monitor 133 may set Guide 1 as (1 vc, 0.6 vc) and Guide 2 as (0.6 vc, 1 vc) based on the target resource amount of a virtual core after recognizing a situation in which the load is concentrated to CPU1. In an example in which the virtual platforms 104a and 104b share the resources equally, each of v11, v12, v21 and v22 may be able to use 0.5 c of CPU at average. Once the guide information is defined, first virtual platform 104a conforms to the set Guide 1, and thus does not perform load balancing. However, second virtual platform 104b may move jobs j9 and j10 that have been originally allocated to v21 to v22 so as to conform to Guide 2.

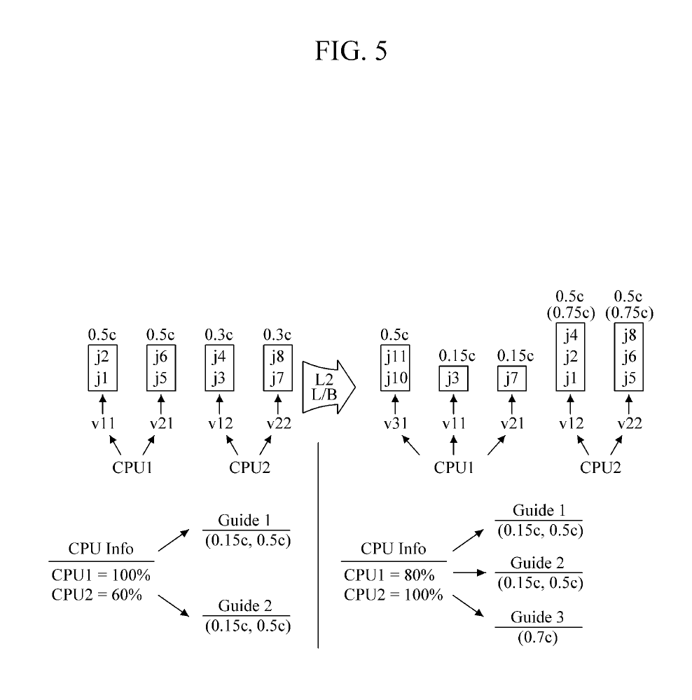

FIG. 5 is a diagram illustrating another example of a scheduling operating of a computing apparatus according to one embodiment of the present disclosure. The example illustrated in FIG. 5 may be applied to the computing apparatus 100 illustrated in FIG. 1 or the computing apparatus 200 illustrated in FIG. 200, in addition to computing apparatuses not specifically described herein, and may assume that a target resource amount of each physical core is used as guide information.

Similar to the example illustrated in FIG. 4, ‘CPU1’ and ‘CPU2’ represent physical cores (or physical processors). ‘v11’ and ‘v21’ represent virtual cores (or virtual processors) that are allocated to ‘CPU1.’ Similarly, ‘v12’ and ‘v22’ represent virtual cores that are allocated to ‘CPU2.’ ‘j1’ to ‘j12’ represent jobs to be executed. ‘CPU Info’ represents resource state information collected by a load monitor 133, and ‘Guide 1’ and ‘Guide 2’ represent guide information for the respective first local scheduler 132a and second local scheduler 132b. In addition, v31 represents a newly added virtual platform.

Referring to FIGS. 1 and 5, this example assumes a policy of fixedly allocating 0.7 c of resource to v31 which is newly added. In this example, the load monitor 133 may set Guide 1 for local scheduler #1 132a as (0.15 c, 0.5 c) and Guide 2 for load scheduler #2 132b as (0.15 c, 0.5 c). Accordingly, first virtual platform 1 104a moves jobs j1 and j2 from v11 to v12 and a job v3 from v12 to v11 by use of first local scheduler 132a. In the same manner, second virtual platform 104b moves jobs j5 and j6 from v21 to v22 and a job j7 from v22 to v21 by use of second local scheduler 132b. After the load balancing, one or both of the virtual platforms 104a and 104b may make a judgment that CPU1 is busy based on the guides even when CPU1 has a remaining resource of 0.2 c. Hence, the load applied on v11 or v21 can be controlled for the resources not to be used more than 0.15 c, and 0.7 c of resources required for v31 can be secured.

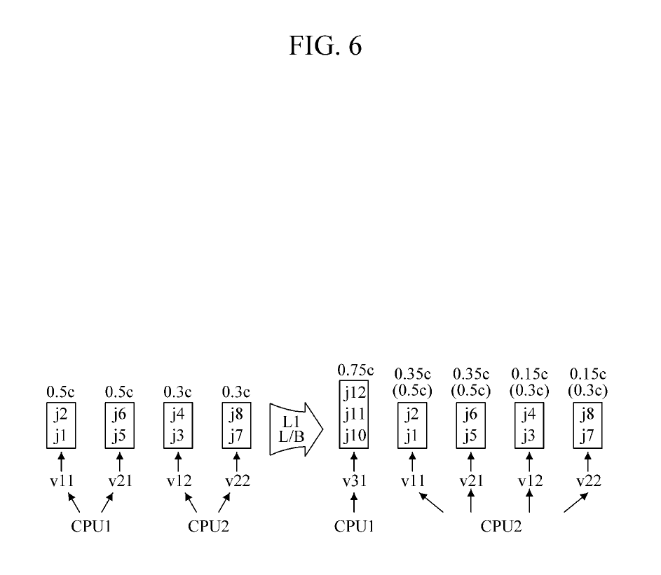

FIG. 6 is a diagram illustrating an example of a load balancing method using a global scheduler according to one embodiment of the present disclosure.

Methods shown in the examples illustrated in FIGS. 3 to 5 primarily use L2 L/B to reduce cache miss penalty which may occurs by L1 L/B. However, in some cases, L1 L/B may be used as shown in the example illustrated in FIG. 6.

If, as shown in FIG. 5, v31 requiring a real-time property is newly added and 1.0 c of resources is allocated to v31, moving v11 and v21 from CPU1 to CPU2 may ensure quick acquisition of necessary resources. Thus, priorities among the global scheduler 131 and the local schedulers 132a and 132b may be adequately set such that L1 L/B can be performed by the global scheduler 131 in some cases. In another example, L1 L/B may be performed to give a certain penalty to a virtual platform that does not conform to the guides.

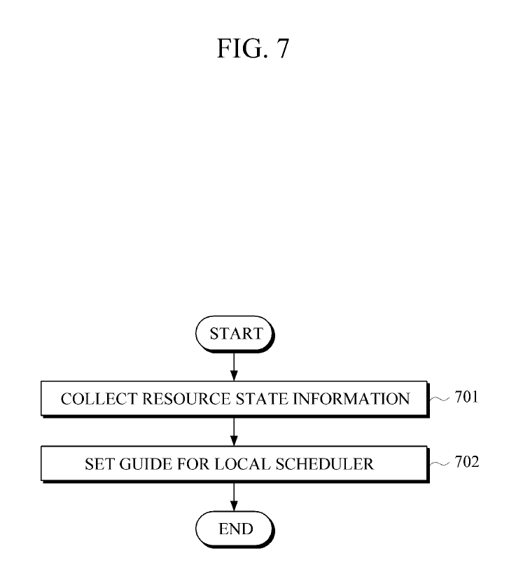

FIG. 7 is a flowchart illustrating an example of a hierarchical scheduling method according to the present disclosure. The example illustrated in FIG. 7 may be applied to a multi-core system that includes hierarchical schedulers.

Referring to FIG. 7, resource state information is collected at 701. For example, referring back to FIG. 1 or 2, the load monitor 133 may collect utilization rate of some or all of the multi-cores 101a, 101b, 101c, and 101d.

In addition, a guide for a local scheduler is set at 702. For example, the load monitor 133 may set guides for schedule operations of one or both of the local schedulers 132a and 132b, with reference to the collected resource state information and/or the set policy. In this example, the guides may be represented based on at least one of a rate of distribution of load among at least one and up to each of the virtual cores 106a, 106b, 106c, 106d, and/or 106e, a target resource amount of at least one and up to each of the virtual cores 106a, 106b, 106c, 106d, and/or 106e, and a target resource amount of at least one and up to each of the physical cores 101a, 101b, 101c, and/or 101d.

Moreover, the set policy may include one or both of a type of a guide for use, and a purpose of a defined schedule. The purpose of schedule may include at least one of priorities between the global scheduler 131 and one or both of the local schedulers 132a and 132b, a scheduling method of the global scheduler 131 and a scheduling method one or both of the local schedulers 132a and 132b in consideration of at least one of the load allocated to at least one and up to each of the physical cores 101a, 101b, 101c, and/or 101d, a power consumption on at least one and up to each of the physical cores 101a, 101b, 101c, and/or 101d, and a temperature of at least one and up to each of the physical cores 101a, 101b, 101c, and/or 101d. For example, as shown in FIG. 6, L1 L/B may be performed according to the policy that reflects the purpose of a schedule.

As described above, since L2 L/B is performed on a job-by-job basis according to a guide that is set on a job group-by-jog group basis in a system including hierarchical schedulers, it is possible to reduce cache miss and to efficiently execute load balancing in accordance with a defined purpose. In addition, since L1 L/B in units of job group is performed with a higher priority than L2 L/B in units of job, it is possible to acquire necessary resources quickly.

A computing system, apparatus or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system, apparatus or computer is a mobile apparatus, a battery may be additionally provided to supply operation voltage of the computing system, apparatus or computer. It will be apparent to those of ordinary skill in the art that the computing system, apparatus or computer may further include an application chipset, a camera image processor (CIS), a mobile Dynamic Random Access Memory (FRAM), and the like. The memory controller and the flash memory device may constitute a solid state drive/disk (SSD) that uses a non-volatile memory to store data.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

Moreover, it is understood that the terminology used herein, for example (physical) cores and (physical) processors, may be different in other applications or when described by another person of ordinary skill in the art.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A computing apparatus comprising:
a global scheduler on a first layer configured to schedule a job group;
a load monitor configured to collect resource state information associated with states of physical resources and set a guide with reference to the collected resource state information and set policy; and
a local scheduler on a second layer configured to schedule jobs belonging to the job group according to the set guide.

2. The computing apparatus of claim 1, wherein the local scheduler comprises a first local scheduler configured to schedule jobs belonging to a first job group and a second local scheduler configured to schedule jobs belonging to a second job group.

3. The computing apparatus of claim 2, wherein the load monitor sets a first guide for the first local scheduler and a second guide for the second local scheduler, wherein the first guide and the second guide are independent of each other.

4. The computing apparatus of claim 1, wherein the first layer comprises a physical platform based on at least one physical core, and the second layer comprises a virtual platform based on at least one virtual core.

5. The computing apparatus of claim 4, wherein the global scheduler is configured to schedule a virtual platform to be executed.

6. The computing apparatus of claim 5, wherein the local scheduler is configured to schedule a job in a scheduled virtual platform.

7. The computing apparatus of claim 4, wherein the guide is represented based on at least one of a rate of distribution of load among the virtual cores, a target resource amount of at least one of the virtual cores, and a target resource amount of at least one of the physical cores.

8. The computing apparatus of claim 7, wherein the set policy comprises a type of a guide for use and a purpose of a defined schedule.

9. The computing apparatus of claim 8, wherein the purpose of a defined schedule comprises at least one of priorities between the global scheduler and the local scheduler, a scheduling method of the global scheduler and a scheduling method of the local scheduler in consideration of at least one of load allocated to each of the physical cores, power consumption of at least one of the physical cores, and a temperature of at least one of the physical cores.

10. The computing apparatus of claim 1, further comprising:
a guide unit configured to transmit the set guide to the local scheduler.

11. The computing apparatus of claim 10, wherein the guide unit is formed on the second layer.

12. The computing apparatus of claim 1, wherein the load monitor is formed on the first layer.

13. The computing apparatus of claim 1, wherein the second layer is formed above the first layer.

14. A computing apparatus comprising:
a first layer based on a physical core and configured to perform load balancing on a job group-by-job group basis using a global scheduler; and
a second layer based on a virtual core and configured to perform load balancing on a job-by-job basis using a local scheduler wherein the jobs correspond to the job group,
wherein the first layer sets a guide related to an operation of the local scheduler according to physical resource states and a set policy.

15. The computing apparatus of claim 14, wherein the local scheduler comprises a first local scheduler configured to schedule a job belonging to a first job group and a second local scheduler configured to schedule a job belonging to a second job group.

16. The computing apparatus of claim 14, wherein the first layer sets a first guide for the first local scheduler and a second guide for the second local scheduler, wherein the first guide and the second guide are independent of each other.

17. The computing apparatus of claim 14, wherein the guide is represented based on at least one of a rate of distribution of load among the virtual cores, a target resource amount of at least one of the virtual cores, and a target resource amount of at least one of the physical cores.

18. The computing apparatus of claim 17, wherein the set policy comprises a type of a guide for use and a purpose of a defined schedule.

19. The computing apparatus of claim 18, wherein the purpose of a defined schedule comprises at least one of priorities between the global scheduler and the local scheduler, a scheduling method of the global scheduler and a scheduling method of the local scheduler in consideration of at least one of load allocated to at least one of the physical cores, power consumption of at least one of the physical cores, and a temperature of at least one of the physical cores.

20. A hierarchical scheduling method of a multi-core computing apparatus which comprises a global scheduler configured to schedule at least one job group on a first layer and a local scheduler configured to schedule a job belonging to the job group on a second layer, the hierarchical scheduling method comprising:
collecting resource state information associated with states of physical resources; and
setting a guide for the local scheduler with reference to the collected resource state information and a set policy.

21. The hierarchical scheduling method of claim 20, wherein the setting of the guide comprises, if the local scheduler comprises a first local scheduler configured to schedule a job belonging to a first job group and a second local scheduler configured to schedule a job belonging to a second job group, setting a first guide for the first local scheduler and a second guide for the second local scheduler, wherein the first guide and the second guide are independent of each other.

22. The hierarchical scheduling method of claim 20, wherein the set guide is represented based on at least one of a rate of distribution of load among virtual cores, a target resource amount of at least one of the virtual cores, and a target resource amount of at least one of physical cores.

23. The hierarchical scheduling method of claim 22, wherein the set policy comprises a type of a guide for use and a purpose of a defined schedule.

24. The hierarchical scheduling method of claim 23, wherein the purpose of a defined schedule comprises at least one of priorities between the global scheduler and the local scheduler, a scheduling method of the global scheduler and a scheduling method of the local scheduler in consideration of at least one of load allocated to at least one of the physical cores, power consumption of at least one of the physical cores, and a temperature of at least one of the physical cores.
